(19) United States
(12) Patent Application Publication
(10) Pub. No.: US 2010/0169185 A1
(43) Pub. Date: Jul. 1, 2010

(54) Self-Designed Maquettes Using Rapid Prototyping

(76) Inventor: Keith Cottingham, San Francisco, CA (US)

Correspondence Address: Lauson & Tarver LLP, 880 Apollo Street, SUITE 301, El Segundo, CA, 90245, US

(21) Appl. No.: 12/486,699

(22) Filed: Jun. 17, 2009

Related U.S. Application Data
(60) Provisional application No. 61/073,631, filed on Jun. 18, 2008.

(51) Int. Cl. G06F 3/01; G06Q 30/00; G06Q 50/00

(52) U.S. Cl. 705/27; 715/760; 715/708

(57) ABSTRACT

A method of creating self-designed maquette toys comprises an Internet-based system for downloading three-dimensional preformed virtual models and downloading editing modules that allow users to manipulate virtual models, add characteristics, modify existing characteristics an otherwise edit a model to create a personalized final product. The finished edited maquette file is exported to an off-site processing facility where the edited three-dimensional virtual model is sculpted into a three-dimensional model to be packaged and shipped to a user.

### CROSS-REFERENCE TO RELATED APPLICATION

This application claims the priority benefit of provisional application No. 61/073,631, filed on Jun. 18, 2008.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The use of rapid prototyping is known in the art. Rapid prototyping machines interpret three-dimensional computer models to sculpt three-dimensional objects resembling the computer models. The programs used to create three-dimensional computer models are typically large stand-alone programs that must be installed on a computer and require substantial education to use. Therefore there is a need for a process that allows users to create and edit three-dimensional models using a web-based program that is easy to learn and use, and that automatically exports completed three-dimensional model files to an off-site location for production and shipping completed rapid-prototyped models to users.

### SUMMARY

The present invention comprises an online method allowing users to edit virtual model templates to create a personalized finished maquette. The edits to template maquettes are rendered and exported to a facility to create a three-dimensional maquette and ship the finished product to the user.

The invention comprises software downloaded from the Internet that runs on a personal computer. A user navigates to a webpage hosting the software which provides an animation showing how to create a maquette and displaying maquettes, modules, and related links. In certain preferred embodiments, the maquettes and modules comprise a display of newly released templates and editing modules. A “create” page displays a brief overview of the maquette creation process, including instructions regarding how to create a maquette and how to purchase a completed maquette. A series of “gallery” pages are linked to the home page. A first gallery page shows sample works. A second gallery page details artists' works along with artist profiles and a section for community comments. In one preferred embodiment, a “games” page provides access to maquette related games and other interactive entertainment.

The webpage also comprises an applet for executing specific maquette editing steps. Once downloaded, the applet presents a “landing page” with options for adding additional editing modules of differing complexity. A “start modules” page offers a list of modules for returning users, and “highlight” pages contain descriptions of intermediate and advanced level modules and instructions on their use. A welcome screen comprises animated information for the maquette designing system, and explains loading modules and how to using the software. Associated with the welcome screen is an “in-process” screen showing a beginner level maquette being created and offering a demonstration of editing tools, navigation tools, options and preview modes. A “proof page” screen summarizes a maquette as a rendered color image and provides a purchase function that takes a user to a web page for purchasing a maquette.

The web shop page comprises a front end store displaying a rendered maquette in addition to accessories. A screen associated with the shop page comprises a shop maquettes page where users can browse and purchase ready-made maquettes without going through the editing process. A second screen associated with the shop page is a “shop other” page offering accessories as well as gallery editions by artists, t-shirts and other apparel, display cases, stands, maquette posters and other maquette related goods.

The first step after downloading the editing software is to chose a basic maquette model. After selecting a type of maquette, a user loads an editing module. In the editing module a user may select to load either just a maquette model, both a maquette model and module(s), or modules only. This selection will determine the tools with which a user can edit a selected maquette. After selecting a module, a module information screen is presented containing information about a particular type of maquette, as well as information from the artist that created the model.

A figure in an editing screen is represented three-dimensionally and can be rotated and resized for editing. By holding down the mouse button after selecting an icon, the mouse becomes a slider control that manipulates the characteristics of the clothing article. Icons are presented on the side of the screen representing an attribute to a character, such as “hair” or an article of clothing such as a “jacket” on the maquette. Once the icon for editing an aspect of a maquette is selected, if the mouse button is held in a depressed position, a slider control appears allowing the user to make the desired color changes.

The user interface for making the changes comprises a slider-bar that appears as long as the mouse button is depressed. Once the user selects the proper color, the mouse button is released and the slider bar turns back into a normally operational cursor. A user may also simply position the mouse cursor over an article to be changed to activate the slider characteristics of the mouse control.

Once a user has completed editing a maquette, the program renders the maquette and its edits into a finished prototype image along with information on the model, including the artist name, country, maquette type, size, etc. Users have the ability to return to maquette editing screens to further edit the maquette, or if the maquette is complete, execute a purchase of the maquette as edited. Once the “buy” option is selected, the program produces a high-resolution rendering of the maquette and sends the file to an off-site location where three-dimensional maquette files are turned into models and packaged for shipping to a user.

### BRIEF DESCRIPTION OF THE FIGURES

FIG. 1 is an organizational flow diagram representing the steps of making a custom designed Maquette.

FIG. 2 is a list of character types presented to a user from which a base prototype maquette may be selected for editing.

FIG. 3 is a sample screen showing the website landing page where user's begin the customization process by selecting a module.

FIG. 4 is a sample screen showing a selected maquette prototype and providing information on the design process.

FIG. 5 shows the welcome screen to the maquette applet of the present invention.

FIG. 6 shows a blank maquette on an editing screen, ready to be customized by a user.

FIG. 7 shows a maquette bearing clothing selected by a user and in the process of editing.

FIG. 8 shows a preview screen where a user can see a rendered maquette and information about the maquette as edited.

FIG. 9 shows a final, high definition rendering of a maquette to be sent for off-site production.

FIG. 10 shows a completed maquette in a box ready for shipping.

### DESCRIPTION

The present invention comprises a method allowing users to selectively edit maquette model templates in a virtual environment to create a real-world personalized finished maquette. The edits performed on the virtual template maquette are rendered and exported to an off-site facility that creates a three dimensional maquette according to the user's design and ships the finished product to the user.

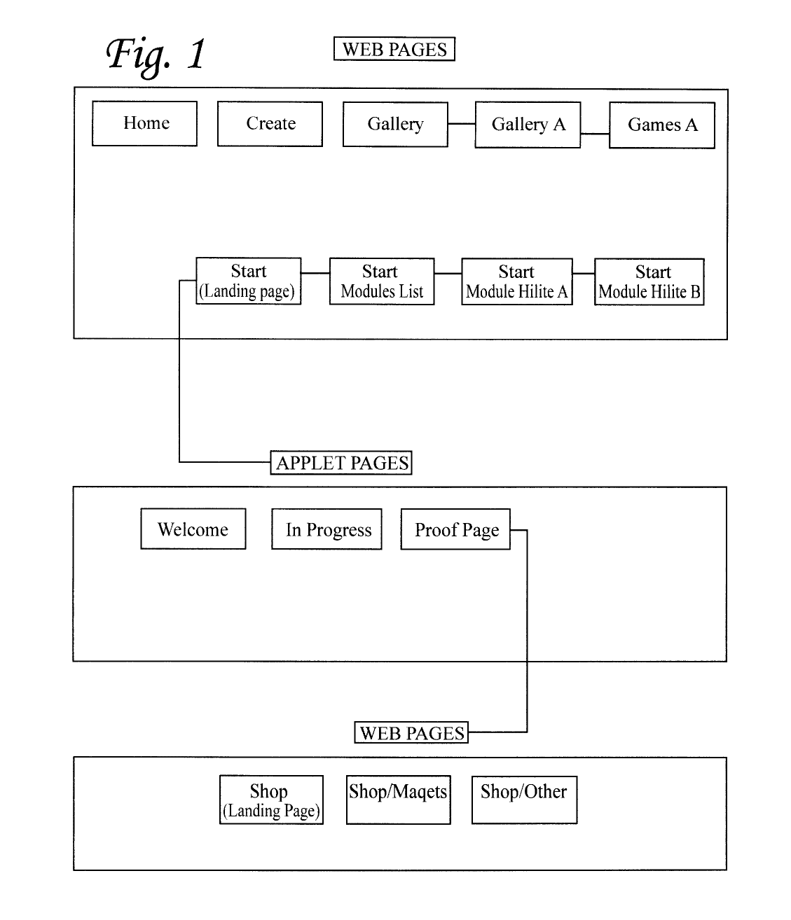

Referring to FIG. 1, the present invention comprises software to be downloaded through a website, game console, or other software based device. The software runs on a user's machine, such as a personal computer, and in certain embodiments may be Internet browser-based. In order to use the system, a user navigates to a webpage hosting the editing program.

A home page 1, provides an animation showing how to create a maquette, and demonstrating a display of maquettes, modules, and news or press links. In certain preferred embodiments, the maquette and module display comprises newly released templates and editing modules available to users. Associated with the home page 1 is a “create” page 2 displaying a brief overview of the maquette creation process, including instructions regarding maquette creation with the program applet, site use and how to purchase a completed maquette. This screen also comprises a “frequently asked questions” section and pricing information as well as an animation showing the complete process.

In addition to the “create” web page, a series of “gallery” pages are also linked to the home page. A first gallery page 3 shows a sample of artists works using the system. A second gallery page 4 details various artists' works, along with providing an artist profile and a section for community comments. In one preferred embodiment, a “games” page provides access to maquette related games and other interactive entertainment.

The webpage presenting the process also comprises an applet download used for executing certain specific steps in maquette editing method. Once the applet is downloaded, a user arrives at a “landing page” 6 providing options for adding additional modules for editing different maquettes of differing complexity. A “start modules” page 7 offers a list of modules for returning users, and “highlight” pages 8 contain descriptions of intermediate and advanced level modules and instructions on their use.

Once the applet is downloaded, a welcome screen 9 appears comprising animated information for using the maquette designing system, and explains how to load modules and how to use the software, save and purchase a maquette. Associated with the welcome screen 9 is an “in-process” screen which shows a beginner level maquette being created and offers a demonstration of available editing tools, navigation tools, options and preview modes. Also associated with the welcome screen 9 is a “proof page” screen 11, which summarizes a user's maquette as a rendered color image and information on the maquette. Also included on the “proof page” screen is a purchase function that, when selected, takes a user to a web shop page 12 for purchasing a maquette.

Still referring to FIG. 1, the web shop page 12 comprises a front end store that displays an edited, rendered maquette in addition to accessories including gallery editions by artists, t-shirts and other apparel, display cases, stands, maquette posters, pillow cases, totes, etc. A screen associated with the shop page 12 comprises a shop maquettes page 13 where users can browse and purchase ready-made maquettes without going through the editing process. A second screen associated with the shop page 12 is a “shop other” page 14 offering accessories as well as gallery editions by artists, t-shirts and other apparel, display cases, stands, maquette posters and other maquette related goods.

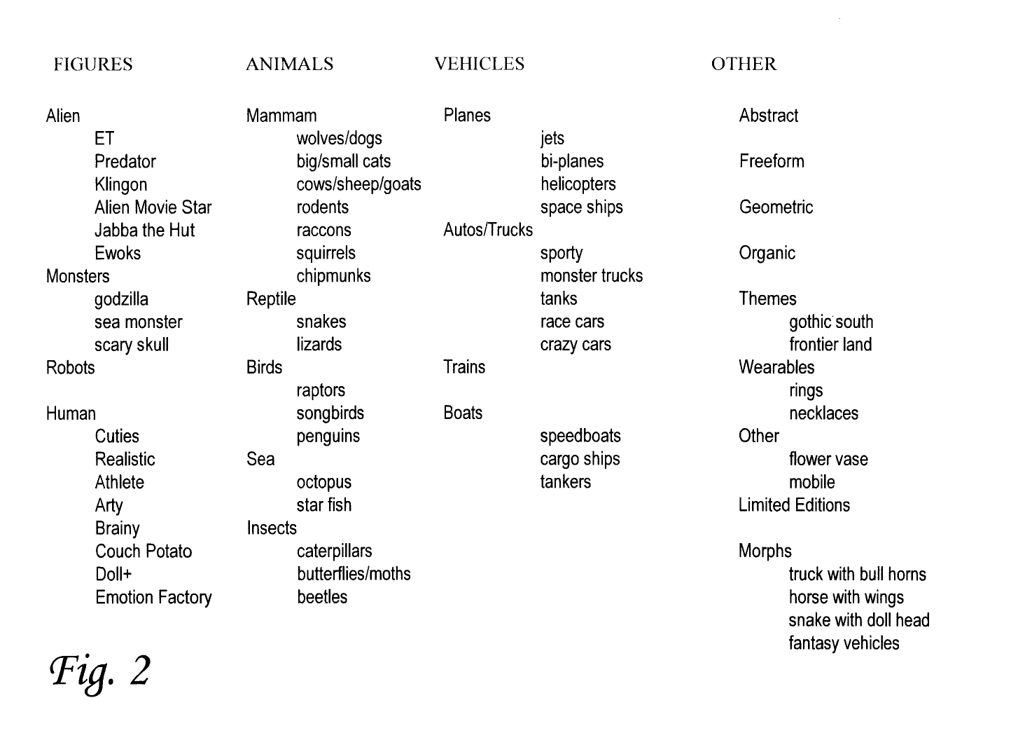

Referring to FIG. 2, a list of maquette templates is shown and described. The first step in the method after downloading the maquette editing software is to chose a basic maquette model with which to work. The types of basic models include Figures, Animals, Vehicles and Other types of maquettes. The Figures are divided into aliens, monsters, robots, and humanoid figures. Animals are divided along roughly phylogenic lines into mammals, reptiles, birds, sea creatures and insects. Vehicles include planes, automobiles, trucks, trains and boats.

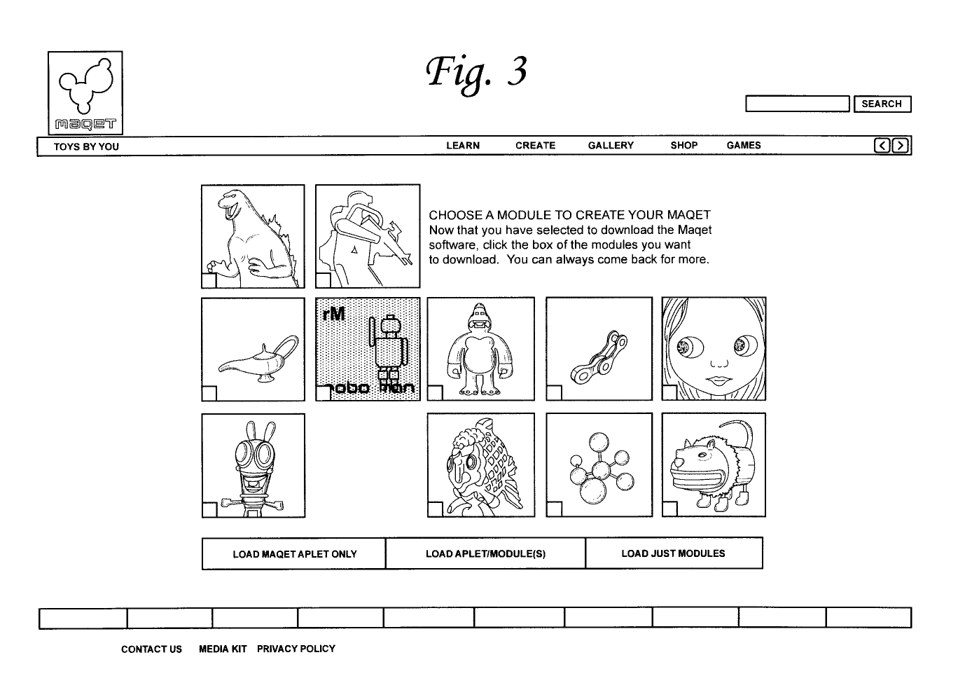

Referring to FIG. 3, after selecting a type of maquette, a user loads a module with which to edit the template maquette. In the module screen a user may select to load either just a maquette model, both a maquette model and module(s), or modules only. This selection will determine the tools with which a user can edit a selected maquette.

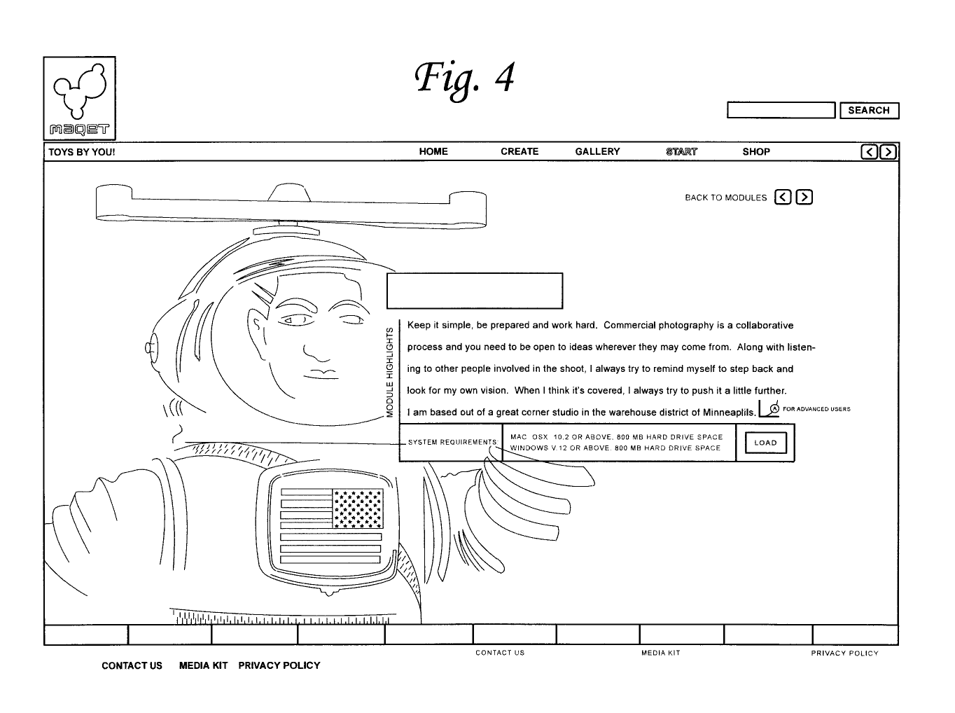

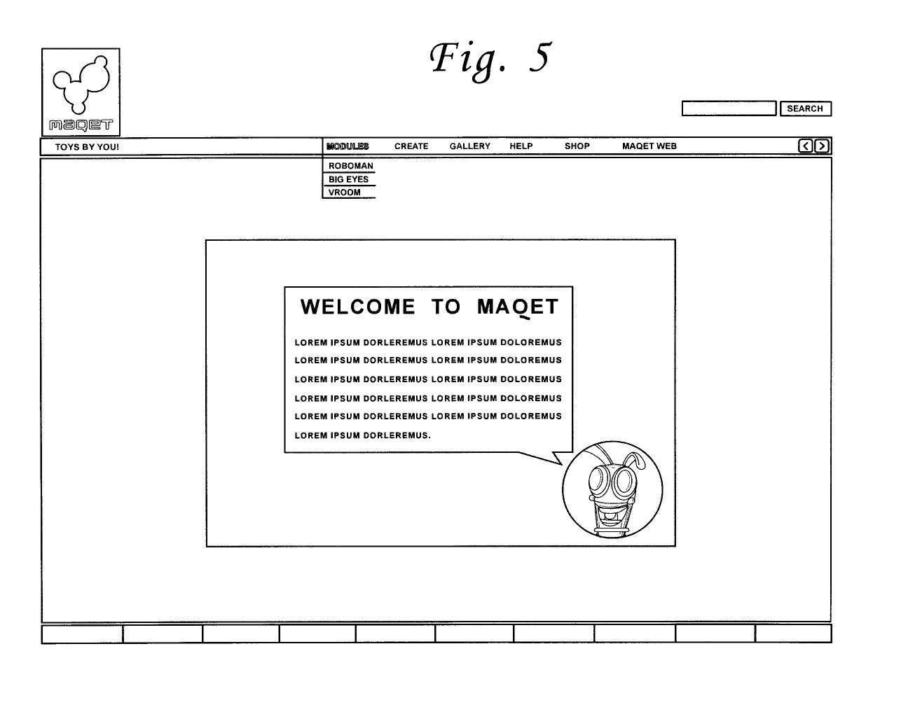

Referring to FIG. 4, after selecting a module, a module information screen is presented to the user. The module information screen contains information about a particular type of maquette, as well as information from the artist that created the model. FIG. 5 shows the welcome screen displayed as the software for a module is being loaded.

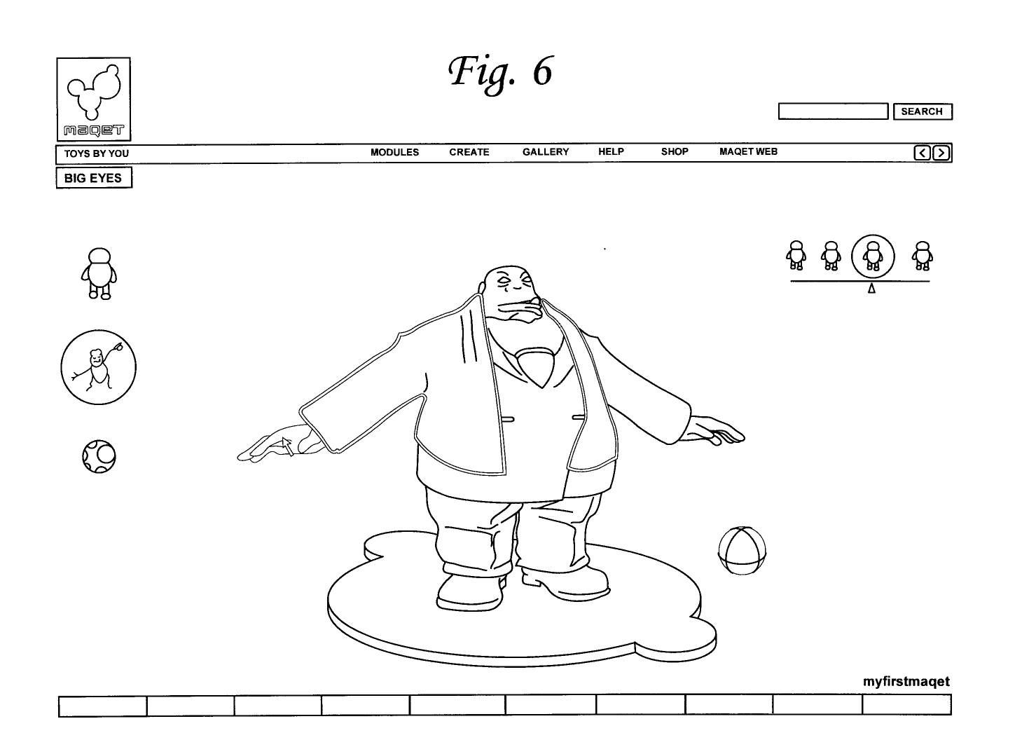

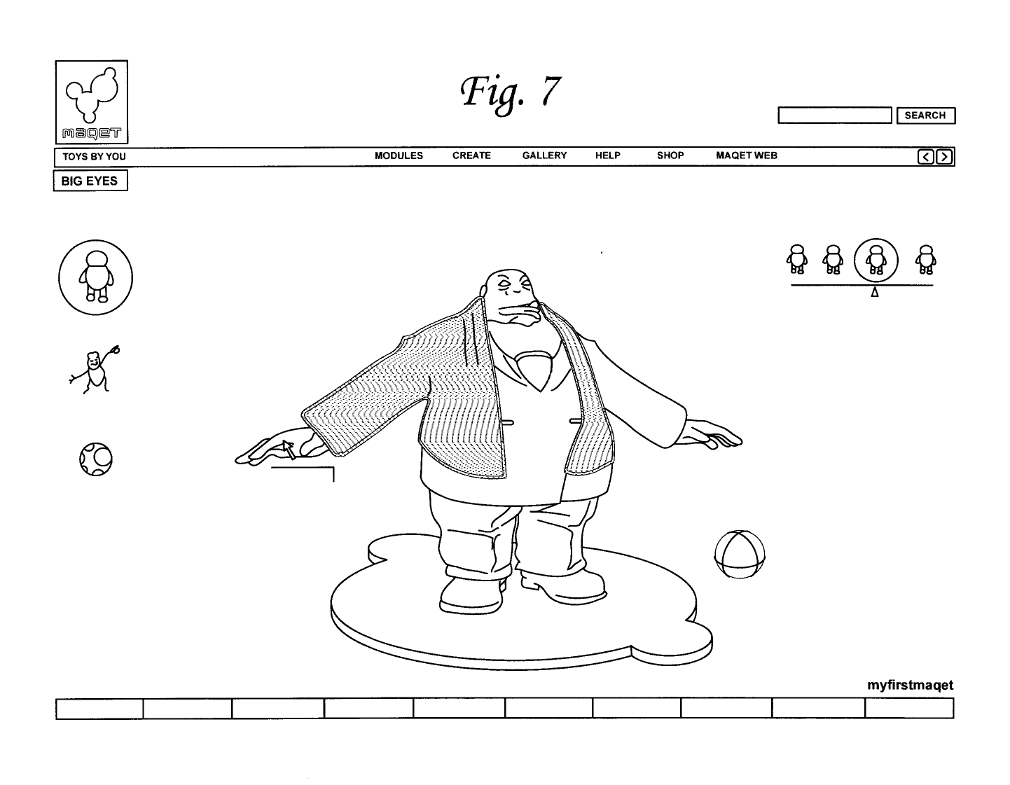

Referring to FIG. 6, a figure in an editing screen is shown. The maquette 101 is represented in an editing screen. The maquette 101 is represented three-dimensionally, and can be rotated and resized for editing. FIG. 7 shows the maquette 101 with an article of clothing 103 selected by a user. By manipulating the mouse, in one embodiment, holding down the mouse button after selecting an icon, the mouse becomes a slider control that manipulates the characteristics of the clothing article.

Regarding the manner of selection and editing, in a preferred embodiment, icons are presented on the side of the screen representing an attribute to a character, such as “hair” or an article of clothing such as a “jacket” on the maquette. These icons may lead to a submenu of icons regarding attributes of the selected icon, such as color, texture, etc. Once the icon for editing an aspect of a maquette is reached; for instance when the user is presented with the icon for formatting the color of an article of a Maquette's clothing, if the mouse button is held in a depressed position, a slider control appears, allowing the user to make the desired color changes.

In a further preferred embodiment, the user interface for making the changes comprises a slider-bar that appears as long as the mouse button is depressed. Once the user selects the proper color, the mouse button is released and the slider bar turns back into a normally operational cursor.

In another preferred embodiment, a user may simply position the mouse cursor over an article to be changed to activate the slider characteristics of the mouse control. In yet another preferred embodiment, selector controls indicating the type of change to be performed may be incorporated. In this manner as an example, a user would select the icon to change the color of a garment. By hovering over the garment, pressing and holding the mouse button, a user employs the slider bar mechanism to change the color of the garment.

In another preferred embodiment, icons may be combined, increasing the number of icons and their level of specificity. For example, instead of three icons indicating “form,” “pose,” and “color,” a user might be presented with six icons indicating: “form-head,” “form-body,” “pose-figure,” “pose-parts,” “color-figure,” and color-parts,” respectively.

In another preferred embodiment, a “mouse-over slider” control is used for editing a maquette. In this embodiment, when a mouse cursor passes over a maquette object part, it highlights, then when the mouse button is depressed, an image in the upper right corner of the screen appears and with a back and forth sliding action, a user causes live updates on the maquette model while small icons are displayed above the slider. As with the other embodiments, releasing the mouse button makes the user's selection.

In another preferred embodiment, navigation icons are used for editing, in this embodiment, when selected, the maquette centers, zooms and orbits around a pivot point pre-set for “full body,” “head,” “hand,” or “foot.” This allows a user to see all surfaces of the part under selection for editing.

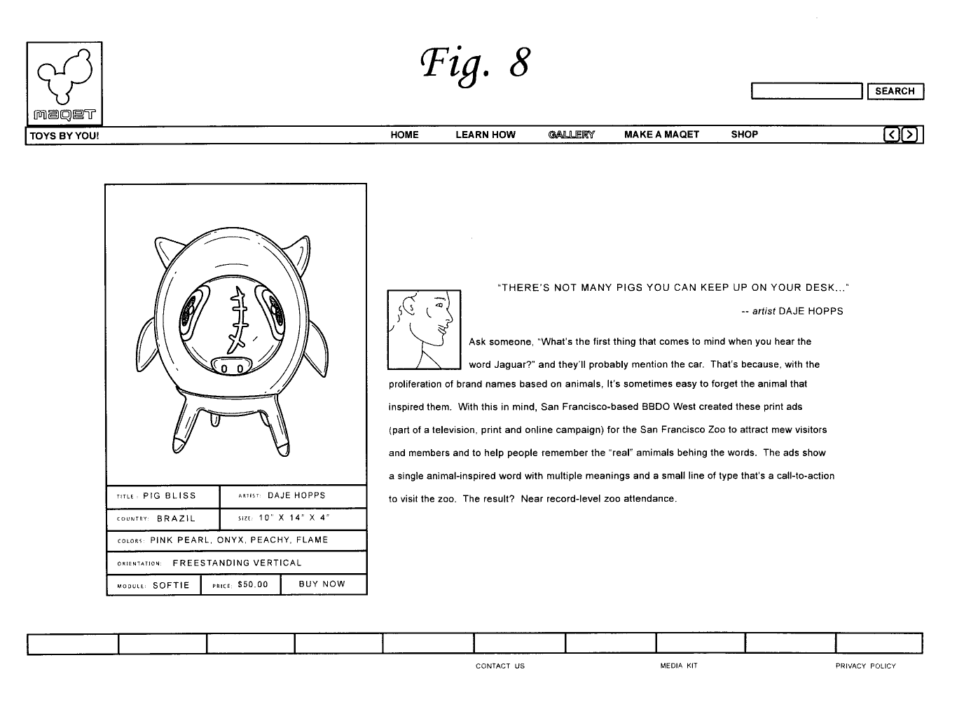

Referring to FIG. 8, a “preview and buy” screen is shown. Once a user has completed editing a maquette, the program renders the maquette and its edits into a finished prototype image along with information on the model, including the artist name, country, maquette type, size, etc. At this stage users have the ability to return to maquette editing screens to further edit the maquette, or if the maquette is complete, execute a purchase of the maquette as edited.

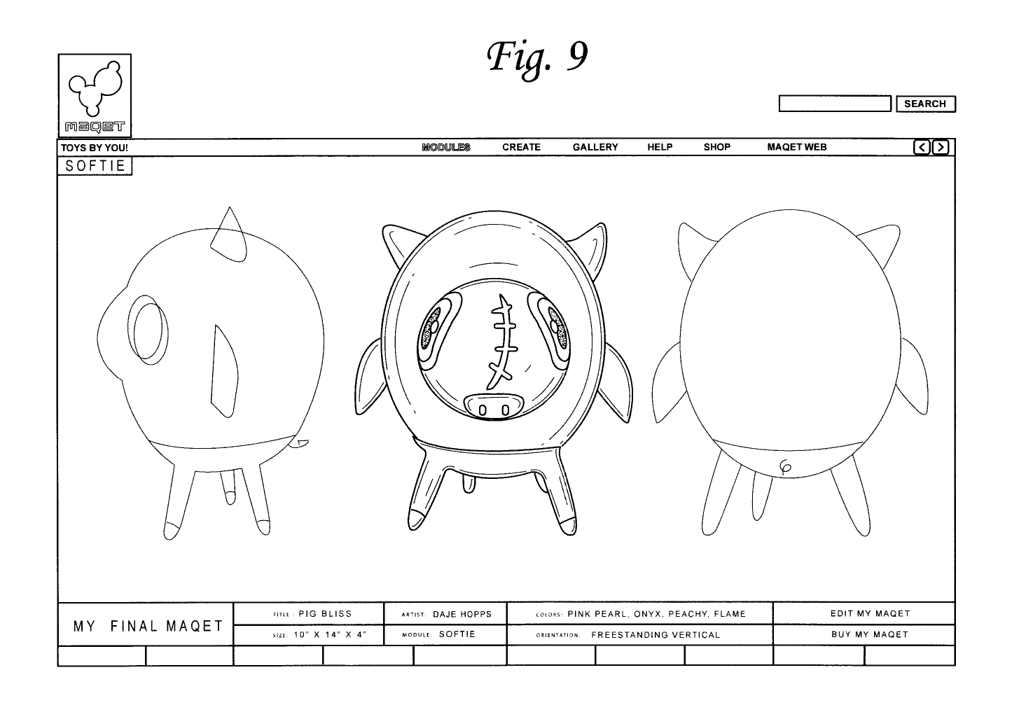

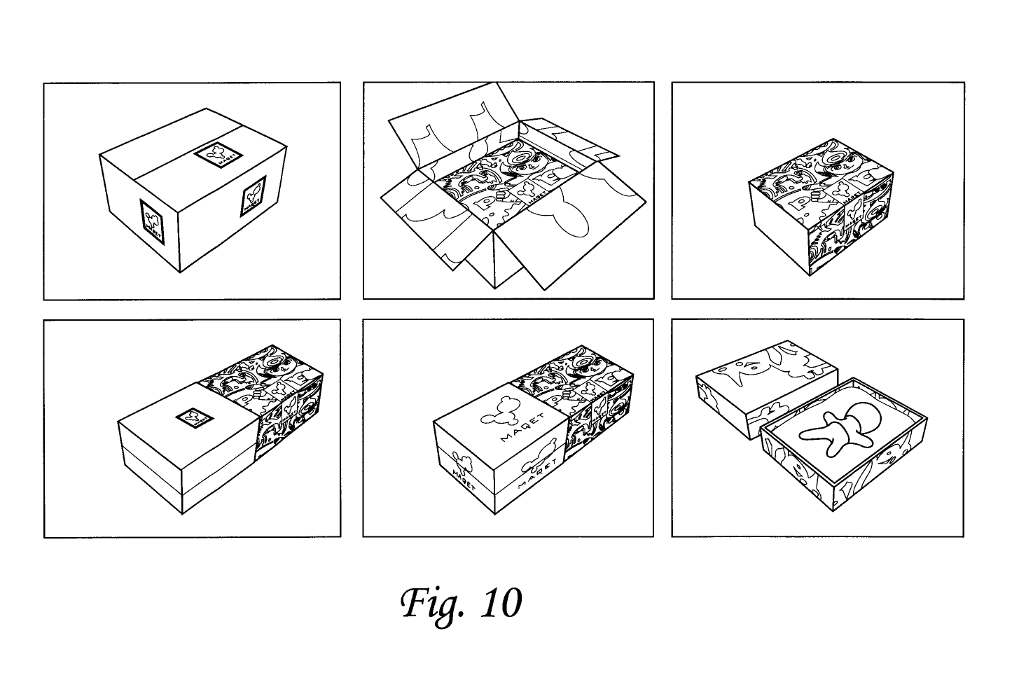

Referring to FIG. 9, once the “buy” option is selected, the program produces a high-resolution rendering of the maquette and sends the file to an off-site location where three-dimensional maquette files are turned into models and packaged for shipping to a user as shown in FIG. 10.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. An improved method of allowing users to make custom self-designed toys based on custom self-designed maquettes comprising the steps of:
a. providing a website hosting a maquette design applet download;
b. providing an applet welcome screen comprising directions for using the maquette system;
c. providing a selection screen for selecting a maquette template;
d. providing a maquette editing system in stages comprising:
i. a “form” stage wherein as the user's mouse slides over the maquette, predetermined portions of the maquette are highlighted and forms applicable to the predetermined portions are selectable;
ii. a “pose” stage wherein as the user's mouse slides over the maquette, predetermined portions of the maquette are highlighted and areas of the maquette pertaining to the predetermined portions can be posed in a variety of positions;
iii. a “color” stage wherein as the user's mouse slides over the maquette, predetermined portions of the maquette are highlighted and areas of the maquette pertaining to the predetermined portions can be rendered in a predetermined color and texture;
e. providing a maquette preview screen, wherein the edited maquette can be previewed in a rendered form, and is rotatable around at least one predetermined axis; and
f. providing a purchase option, wherein the model is converted to a file and processed into a physical representation of the maquette at an offsite rapid-prototyping facility.

2. The method of claim 1, wherein the website comprises one or more webpages chosen from the following list: a home page introducing the maquette designing process, a create page showing how users create toys from maquettes, a gallery showing artwork, details of works, artist profiles and community comments, and a games and entertainment page.

3. The method of claim 1, wherein the website comprises one or more pages chosen from the following list: a start module page showing a module and its tools as a tutorial at various skill levels, a list of modules, a download page, an option to add additional modules.

4. The method of claim 1, wherein the applet comprises a welcome screen showing how to load a module, and how to use, save and purchase a maquette.

5. The method of claim 4, wherein the welcome screen comprises animated characters.

6. The method of claim 1, wherein the applet comprises an in-process screen that shows a beginner level maquette being created, and includes a demo of editing tools, navigation, options and previous options available to users.

7. The method of claim 1, wherein the applet comprises a proof screen that summarizes a maquette with a rendered image, includes other information pertaining to the character represented by the maquette, and a purchase option to purchase the finished maquette.

8. The method of claim 1, wherein once the purchase option is selected a user is presented with an online store screen showing the finished maquette, and allows the user to input purchase and delivery information.

9. The method of claim 8, wherein the online store screen allows a purchaser to personalize a maquette with ancillary character information regarding the maquette.

10. The method of claim 8, wherein the online store screen allows users to shop for ready-made maquettes.

11. The method of claim 8 wherein the online store screen allows users to shop for accessories, gallery editions by artists, apparel, display supports, and display cases.

12. The method of claim 1, wherein the selectable maquette types are chosen from the list of: humanoid figures, including aliens, monsters, robots, and humans; Animals, including mammals, reptiles, birds, sea creatures, and insects; vehicles, including planes, autos, trucks, trains and boats; and other forms including abstract forms, freeform forms, geometric forms, organic forms, wearable articles; and morphs comprising combinations of any of the above.

13. The method of claim 1, wherein during the “pose” stage, users can select multiple selectable poses that can be modified by using an on-screen slider activated by the user.

14. The method of claim 1, wherein during the “color” stage, users can select multiple colors, textures and surface patters appearing three-dimensional that can be modified using an on-screen slider activated by the user.

15. The method of claim 1, wherein a user may preview a maquette as a higher resolution rendering at any time during the maquette customization process.

16. The method of claim 1, wherein a “final preview” selection summarizes a user's maquette with a realistic rendering and provides information on the character chosen from the list of: toy name, artist, country made, dimensions, date, module used, notes composed by the user, and price.

17. The method of claim 1, wherein after the “buy” option is selected, a user's edited maquette is exported electronically to an off-site rapid-prototyping system, processed at a factory, and packaged and shipped to a user.

18. The method of claim 1, wherein when the user's mouse is held in a selected, button down, position, it functions as a slider for gradually changing the characteristics of a selected part, and when the mouse selector is released editing ceases and the mouse pointer returns to normal functioning.

19. The method of claim 18, wherein as the mouse operates as a slider, the user's sliding movements are transposed to a visual cue on the screen pertaining to a particular stage to provide visual feedback.
